(19) United States
(12) Patent Application Publication
(10) Pub. No.: US 2023/0087886 A1
(43) Pub. Date: Mar. 23, 2023

(54) System and Method for Monitoring, Analyzing and Controlling Emissions in A Plant

(71) Applicant: Suncor Energy Inc., Calgary (CA)

(72) Inventors: Daniel Martin BURT, Cochran (CA); Thomas Christopher LASKOWSKI, Calgary (CA); Michael Allen DeWITT, Fort McMurray (CA)

(73) Assignee: Suncor Energy Inc., Calgary, AB (CA)

(21) Appl. No.: 17/823,146

(22) Filed: Aug. 30, 2022

(30) Foreign Application Priority Data
Sep. 21, 2021 (CA) 3131637

(51) Int. Cl. G05B 19/418

(52) U.S. Cl. CPC G05B 19/41865; G05B 2219/32021

(57) ABSTRACT

A system and method are provided for determining operational parameters for improving energy efficiency of a process. The method includes obtaining energy usage data and production and operating data generated by utilizing at least one utility in the process and using the energy data and production and operating data to generate a first principles model. The method also includes obtaining sensor data from at least one sensor coupled to equipment used during operation of the process; generating an efficiency model using at least one data driven model, the sensor data, and the first principles model; and using the efficiency model to generate an energy optimization to achieve a greenhouse gas reduction in operation of the process. The method also includes generating an output comprising at least one operation parameter value to enable adjustment of the equipment to adjust operation of the process towards the greenhouse gas reduction; and providing the output to an operational controller.

### CROSS-REFERENCE TO RELATED APPLICATION(S)

This application claims priority to Canadian Patent Application No. 3,131,637 filed on Sep. 22, 2021, the entire contents of which are incorporated herein by reference.

### TECHNICAL FIELD

The following generally relates to energy usage and emissions from energy usage in an industrial plant, in particular to systems and methods for monitoring, analyzing and controlling emissions in such a plant.

### BACKGROUND

Many heavy industries, such as oil, gas, and utilities (e.g., power generation), operate large machinery and equipment, often referred to as plants. These plants typically consume energy and input materials to produce an output material. In the course of consuming the energy and processing the input materials, unwanted by-products such as green house gas emissions are normally produced. To increase the economics of the plant, it is desirable to reduce the amount of energy consumed in order to meet a particular production target. Regulatory and other process constraints can also affect the emissions that are permitted for a given plant or an industrial process involving one or more plants.

Emissions such as greenhouse gases (GHGs) have traditionally been quantified using largely manual efforts with a combination of measured data and engineering calculations. Moreover, GHGs and energy usage are typically calculated weeks or even months after the fact, with mitigation plans being developed only for the next planning cycle for the plant or system. In this way, the immediate impact of suboptimal use of utilities on energy costs and emissions can be difficult to quantify and can leave operators in a reactive mode after significant lags.

### SUMMARY

The following provides a system and method that is configured to implement a process model based application to generate energy-optimized operating scenarios resulting in GHG emission reductions, improving decision making and operating guidance. The system can model an entire process that impacts energy efficiency and adjust control parameters (within given constraints) to operate the process in a more energy efficient way, thus reducing GHG emissions. The system provides the ability to implement a hybrid modeling approach by using first principles models, data driven models, and sensor data to obtain the parameter data used to optimize the process.

In one aspect, there is provided a method of determining operational parameters for improving energy efficiency of a process, comprising: obtaining energy usage data and production and operating data generated by utilizing at least one utility in the process; using the energy data and production and operating data to generate a first principles model; obtaining sensor data from at least one sensor coupled to equipment used during operation of the process; generating an efficiency model using at least one data driven model, the sensor data, and the first principles model; using the efficiency model to generate an energy optimization to achieve a greenhouse gas reduction in operation of the process; generating an output comprising at least one operation parameter value to enable adjustment of the equipment to adjust operation of the process towards the greenhouse gas reduction; and providing the output to an operational controller.

In another aspect, there is provided a computer readable medium comprising computer executable instructions for determining operational parameters for improving energy efficiency of a process, comprising instructions for: obtaining energy usage data and production and operating data generated by utilizing at least one utility in the process; using the energy data and production and operating data to generate a first principles model; obtaining sensor data from at least one sensor coupled to equipment used during operation of the process; generating an efficiency model using at least one data driven model, the sensor data, and the first principles model; using the efficiency model to generate an energy optimization to achieve a greenhouse gas reduction in operation of the process; generating an output comprising at least one operation parameter value to enable adjustment of the equipment to adjust operation of the process towards the greenhouse gas reduction; and providing the output to an operational controller.

In another aspect, there is provided a system for determining operational parameters for improving energy efficiency of a process, the system comprising a processor, memory, and at least one data communication interface, the memory comprising computer executable instructions that when executed by the processor, cause the processor to: obtain energy usage data and production and operating data generated by utilizing at least one utility in the process; use the energy data and production and operating data to generate a first principles model; obtain sensor data from at least one sensor coupled to equipment used during operation of the process; generate an efficiency model using at least one data driven model, the sensor data, and the first principles model; use the efficiency model to generate an energy optimization to achieve a greenhouse gas reduction in operation of the process; generate an output comprising at least one operation parameter value to enable adjustment of the equipment to adjust operation of the process towards the greenhouse gas reduction; and provide the output to an operational controller.

In an implementation, the sensor data can include real-time or near-real-time usage data associated with the at least one utility.

In an implementation, the operational controller can include a device configured to automatically apply the at least one adjustment.

In an implementation, the operational controller can include an operator instructed to perform at least one manual adjustment.

In an implementation, the energy usage data can include emissions data.

In an implementation, the method can include obtaining at least one process constraint; and using the at least one process constraint in generating the efficiency model.

In an implementation, the method can include obtaining at least one production target; and using the at least one production target in generating the efficiency model.

In an implementation, the method can include obtaining pricing data associated with energy consumption used in the process; and using the pricing data in performing the energy optimization.

In an implementation, the method can include generating energy and/or greenhouse gas cost values associated with the process; and feeding the energy and/or greenhouse gas cost values to the efficiency model to refine the efficiency model. The feedback for the efficiency model can be provided prior to generating the operational parameters to iterate the energy optimization.

In an implementation, the equipment can be operable within an industrial plant.

In an implementation, the sensor data can further include soft sensor data.

In an implementation, the process can include at least one of recovery, upgrading, refining, and use of a utility, in processing a hydrocarbon. The hydrocarbon can include bitumen.

In an implementation, the method can include receiving data from a separate energy monitoring system; and utilizing the data from the energy monitoring system in generating the energy optimization.

In an implementation, the method can include obtaining data from a data historian. The method can also include feeding the at least one operation parameter value back to the data historian.

In an implementation, the method can include connecting to the operational controller in a plant implementing the process over an electronic data communications network.

In an implementation, the method can include connecting to the at least one sensor in a plant implementing the process over an electronic data communications network.

In an implementation, the method can include providing information indicative of the energy optimization and the output to an application comprising a graphical user interface. The application can be a mobile app.

In an implementation, the energy efficiency model can be generated by using the first principles model to expand the at least one data driven model while incorporating sensor data when applicable to increase model accuracy.

In an implementation, the at least one data driven model can be used to apply data analytics to the sensor data, energy data, and production and operating data.

Advantages of the system and method can include an ability to quantify GHG emissions from the operation of such units in real-time or near-real-time. In this way, one can obtain real-time or near real-time energy optimization and/or GHG emissions reductions advice (e.g., actionable recommendations) or operational parameters to be used automatically or by engineers and operators.

### BRIEF DESCRIPTION OF THE DRAWINGS

Embodiments will now be described with reference to the appended drawings wherein:

FIG. 1 is a schematic diagram of an example of a configuration for an emissions monitoring system.

FIG. 2 is a schematic diagram of an example of a configuration for a steam system.

FIG. 3 is a graph illustrating a traditional energy monitoring system curve against an optimized prediction curve.

FIG. 4 is a schematic diagram of a process flow for implementing an emissions monitoring process.

FIG. 5 is a flow chart illustrating an example of a computer executable process for performing an energy optimization to determine operational parameters or parameter adjustments for a plant.

FIG. 6 is a schematic block diagram of an example of a configuration for a client device coupled to an emissions monitoring system.

FIG. 7 is a flow chart illustrating computer executable operations that can be executed in determining operational parameters for improving energy efficiency of a process.

### DETAILED DESCRIPTION

Equipment and units in a plant are often limited to individual optimization. However, the system impacts are not considered due to complexity and limitations of current tools. For example, an opportunity exists in the oil industry and other heavy industries to optimize energy use, for example by optimizing fuel gas usage, steam, and heat integration across upgrading, refining, recovery, utilities, and other operating units. The following provides a system that can quantify GHG emissions from the operation of such units in real-time or near-real-time. In this way, one can obtain real-time or near real-time energy optimization and/or GHG emissions reductions advice (e.g., actionable recommendations) or operational parameters to be used automatically or by engineers and operators.

The system can also be used to establish a baseline such that process engineering personnel have a point of reference to better quantify GHG emissions. This also provides the ability to drill down on data inputs and outputs such as heat, energy balance and other variables contributing to GHGs. Moreover, the system provides the ability to view the effect on GHG emissions data caused by certain operational data based on individual plants or industrial processes. This then provides the ability to consume the operational advice in a common energy dashboard at shift intervals or otherwise at more frequent or “on demand” intervals, rather than only considering GHG emissions at planning or otherwise longer intervals.

A computer-implemented system provides a new approach to estimating detailed GHG emissions data at a frequency that allows operations personnel and engineers to make better-informed decisions at an operational control level. The system is operable to optimize energy usage within a facility, on an ongoing basis (e.g., in real-time) rather than examining GHGs and energy usage after the fact.

The system can integrate asset data systems, energy/production data (both historical and ongoing) and processes and modeling to apply data analytics in a way that allows operators to make more real-time operational decisions to meet production plans in less energy- and GHG-intensive ways by identifying the independent control variables that affect GHG emissions performance.

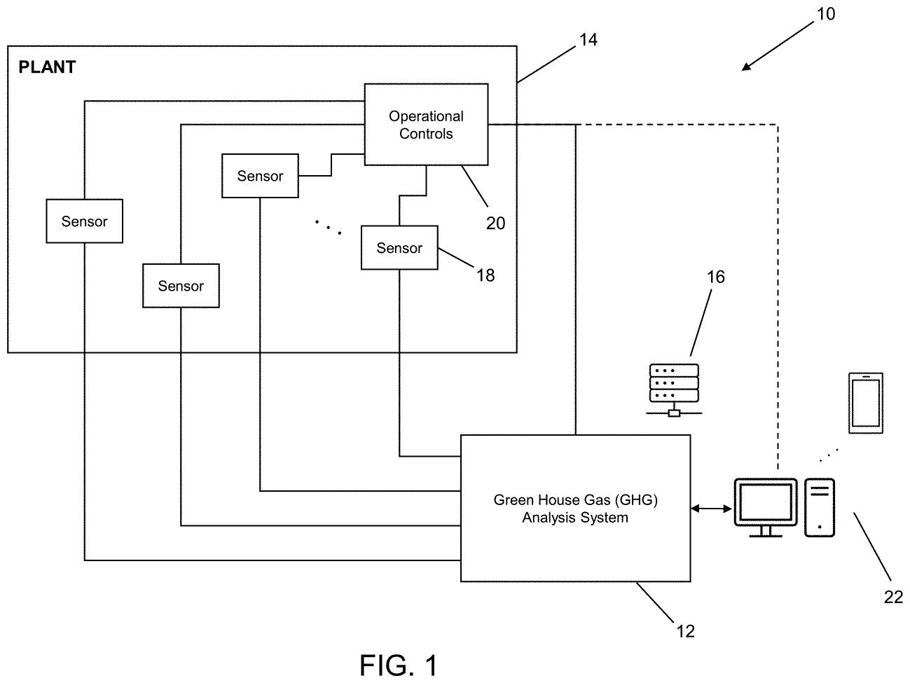

Turning now to the figures, FIG. 1 illustrates an example of an energy usage and emissions monitoring system 10, hereinafter also referred to as the “monitoring system” 10. The monitoring system 10 includes a GHG analysis system 12 that can be coupled or otherwise interfaced with a plant 14 to analyze energy usage and emissions associated with one or more processes implemented in the plant 14 to optimize such energy usage and reduce GHG emissions. In the example configuration shown in FIG. 1, the GHG analysis system 12 is connected to or otherwise capable of being in communication with sensors 18 embedded in or coupled to equipment used by the one or more processes implemented in the plant 14. It can be appreciated that the sensors 18 shown in FIG. 1 can include sensors specific to emissions monitoring as well as sensors used in the instrumentation in the plant 14, such as sensors configured to measure pressure, temperature, flow, etc. The sensors 18 can also represent so-called “soft” sensors that use available data to mathematically represent data not provided by an installed physical sensor 18 used in the instrumentation network in the plant 14.

Such connectivity can be provided, as illustrated, using an electronic network 16 such as a wired or a wireless communication system, for example, an existing enterprise communication infrastructure or purpose built network for the monitoring system 12. The electronic network 16 can include a communications network such as a telephone network, cellular, and/or data communication network to connect different types of communication devices. For example, the network 16 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The GHG analysis system 12 can also be connected to or otherwise in communication with one or more operational controls 20 in the plant 14. Such operational controls 20 can include an electronic control system integrated with or coupled to certain equipment and/or sensors 18 in the plant 14 or can represent a device or communication medium with which to provide operational advice, parameter values or other information and data to an operator that is positioned to perform a manual adjustment or other manual operation to the equipment or a control system therefor within the plant 14 and its environment. It can be appreciated that the GHG analysis system 12 can be configured to obtain sensor data directly from the sensors 18 or via the operational controls 20 according to the connectivity available, data access permissions, etc.

The GHG analysis system 12 can be coupled to or include a client device 22. The client device 22 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, and any additional or alternate computing device, and may be operable to transmit and receive data across the electronic network 16. The client device 22 also provides an ability to view and interact with a graphical user interface. The graphical user interface can be implemented using a web browser or stand-alone application (e.g., mobile app) running locally on the client device 22. The graphical user interface can also be accessed through a network connection over network 16 to a server-based application hosted elsewhere within an enterprise associated with the plant 14. However, it can be appreciated that the GHG analysis system 12 can also be provided as a third party service that is not necessarily associated with an enterprise that operates or is responsible for the plant 14. For example, such a third party service can be provided as a cloud-based service to multiple enterprises or plants with centralized or distributed control, including local instances deployed for each client device 12. That is, the system configuration shown in FIG. 1 is illustrative and various computing architectures and configurations thereof can be implemented within the principles discussed herein.

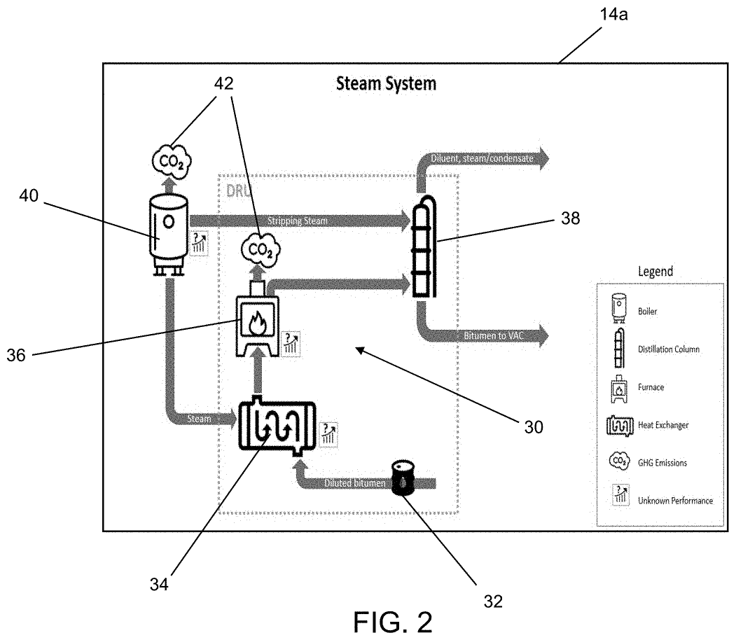

Referring to FIG. 2, an example of a plant 14 is shown, namely a steam system 14a. The steam system 14a utilizes certain equipment 30 that consume energy and, in many cases, produce emissions such as CO₂ at 42. In this example, the equipment 30 used in the steam system 14a includes a heat exchanger 34 with steam and diluted bitumen 32 as inputs, a furnace 36, a distillation column 38 and a boiler 40. It can be seen in this example that the boiler 40 and furnace 36 produce CO₂ emissions 42 and the boiler 40, furnace 36 and heat exchanger 34 typically include unknown performance metrics that are to be modeled, analyzed and optimized using the GHG analysis system 12. In this way, the monitoring system 10 can be used to oversee and, in at least some circumstances, control the operation of the plant 14 to improve performance of the equipment 30 in achieving an emissions reduction target or objective. It can be appreciated that, as discussed below, these targets or objectives can also be balanced with constraints imposed upon the environment or plant 14, such as production targets, production specification/parameters, safety specifications, costs, and other process-related constraints.

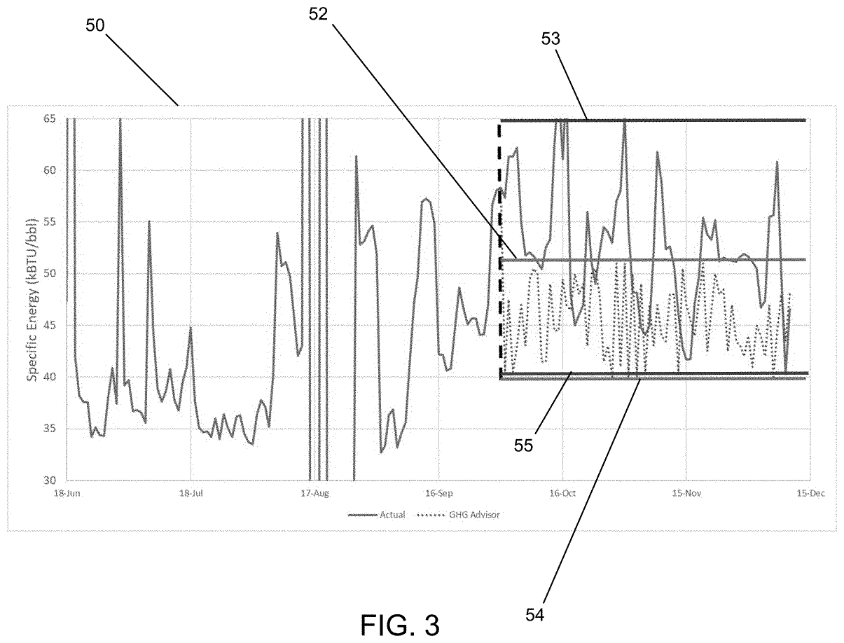

FIG. 3 illustrates a graph showing sample expected results to compare a traditional energy monitoring system output with the predictive optimizations that can be produced by the GHG analysis system 12. The traditional energy monitoring system tool allows users to track past energy use and retroactively analyze performance, e.g., to make reactive adjustments. As illustrated in FIG. 3, with the GHG analysis system 12, opportunities to optimize the plant 14 to achieve reductions in variability of energy intensity and the reduction of energy consumption can be performed in real-time or near-real-time to provide ongoing optimization of the system being monitored. The upper and lower lines 52, 54 demonstrate a reduction in variability of energy intensity as an output of the GHG analysis system's optimization, versus the energy intensity variability without the optimization recommended by the GHG analysis system 12 as demonstrated by the upper and lower lines 53, 55. That is, the GHG analysis system 12 can predict optimum plant performance based on current conditions while meeting the forementioned constraints, such as safety and production specifications.

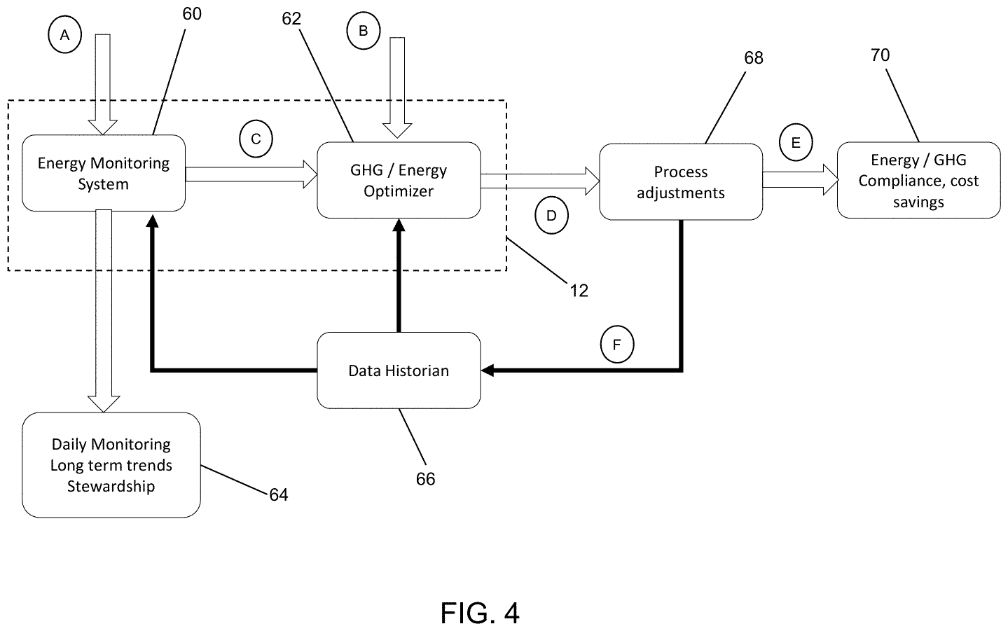

As illustrated in FIG. 4, an energy monitoring system 60 and a GHG/Energy optimizer 62 can be integrated into the same software platform, namely within the GHG analysis system 12, to allow these tools to be complimentary to each other. In this way, operators, technicians, or analysts can begin with the energy monitoring system 60 at stage A or with the GHG/Energy Optimizer 62 at stage B to conduct monitoring of a plant 14. For example, at stage C, performance opportunities can be identified at the plant or unit level by the energy monitoring system 60 and this information can be fed into the GHG/Energy optimizer 62 to generate optimization scenarios and operational guidance at stage D. The energy monitoring system 60 can also generate daily monitoring reports and provide long term trends and stewardship of the operation at 64.

As discussed above, the optimization scenarios and operational guidance can provide process adjustments 68 for the operational controls 20 in the plant 14, which in turn can provide energy/GHG compliance or cost savings outcomes 70 at stage E. The new operational data and the recommended operating information resulting from the process adjustments 68 will be new input(s) to a data historian 66 at stage F. The workflow configuration shown in FIG. 4 also permits the data historian 66 application to feed the process optimizations and process adjustments 68 back to the energy monitoring system 60 and GHG/energy optimizer 62. The GHG analysis system 12 can take the data historian data, calculate new data, and feed the new data back into the data historian 66 so that it can be accessed and used by operations, process engineering, dashboards and other applications that can consume the data.

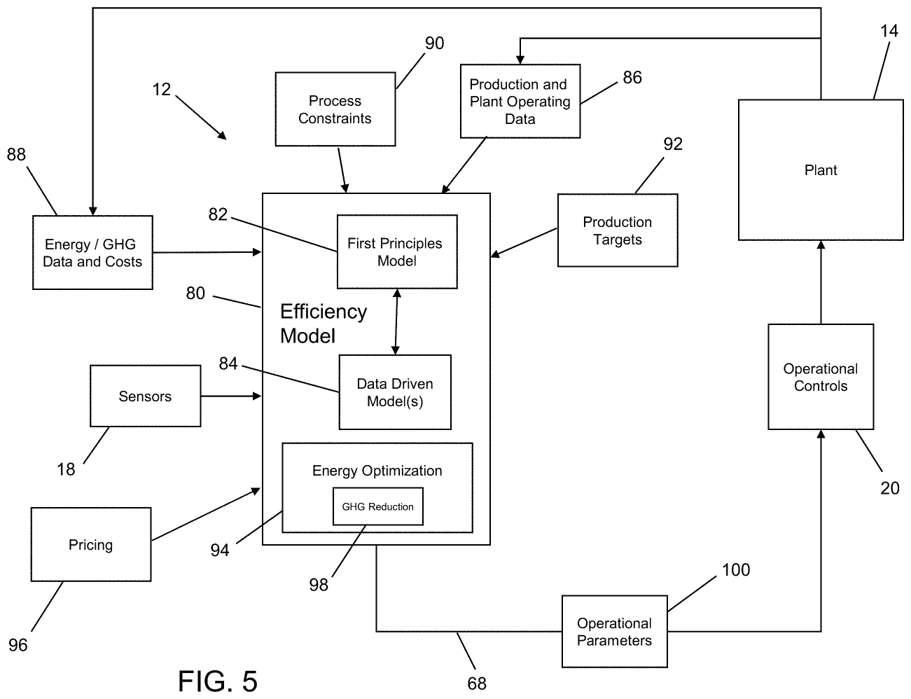

FIG. 5 illustrates functional modules, inputs and outputs utilized by the GHG analysis system 12 to conduct energy optimizations and generate process adjustments, settings or other input to instruct or provide operational controls 20 that can be applied in the plant 14 to achieve emission reductions within the constraints and parameters dictated by the particular application. The GHG analysis system 12 generates, refines, and utilizes an efficiency model 80 that leverages both, or each independently, a first principles model 82 and one or more data driven models 84 (e.g., incorporating conventional or advanced data analytics) to generate energy optimization advice 94 that achieves an objective such as GHG reduction 98. Such advice 94 can include, without limitation, energy optimized operating scenarios, recommended changes to operational parameters, and recommended changes to process setpoints. The efficiency model 80 utilizes data it receives from the sensors 18 to input data and information not provided by energy/GHG data and costs 88 or the production and plant operating data 86 in the first principles model 82 using the data driven model(s) 84. That is, the efficiency model 80 can utilize a hybrid modelling approach or strategy, which balances the more costly and time intensive first principles modeling 82 of the environment being analyzed, with the more dynamic conventional or advanced data analytics provided by implementing the data driven models 84 and the use of soft sensors or a mathematical representation of a physical sensor 18 to fill in gaps in the data (e.g., where physical sensors are not available) as well as any physical sensors 18. This hybrid model considers the individual plants and the entire industrial process and uses operational data to optimize energy usage and thus minimize or control GHG emissions on an ongoing basis, in a way that can account for current parameters.

To generate the first principles model 82, the GHG analysis system 12 obtains energy/GHG and cost data 88 such as historical energy usage and GHG emissions data generated by or observed from, for example, the equipment 30 in the plant 14. The GHG analysis system 12 also obtains production and plant operating data 86, which is indicative of the outputs or production, product quality, feedstock quality, and the operating parameters of the plant 14 being analyzed; and process constraints 90, which can inform the efficiency model 80 regarding the bounds of what can be optimized. For example, the process constraints may include upper or lower operational safety limits on certain equipment 30, product quality targets, or other parameters that cannot be exceed without introducing an adverse effect. Additionally, the GHG analysis system 12 can obtain production targets 92, which indicates any constraints related to production, such as a predefined target throughput that should be met. This allows the efficiency model 80 to balance competing objectives such as energy optimization with practical or “real-world” constraints such as those placed on the operation of the plant 14. Another set of inputs to the efficiency model 80 can include pricing 96 associated with various feed materials, products, consumables, and other commodities. Pricing 96 can include, but is not limited to, the prices of feedstock or raw material, products, fuel, energy inputs, and GHG compliance costs. With these inputs, the efficiency model 80 can be built and trained over time by continually receiving feedback data such as new/current production and plant operating data 86 and energy/GHG data 88, as well as adapting to any changes in production targets 92 or process constraints 90. The energy/GHG data 88, the production and plant operating data 86, and the sensors 18 can also provide a real-time or near-real-time gauge on how the efficiency model 80 is performing and whether previous changes have been successful.

The efficiency model 80 can be built using a commercially available digital optimization technology. The commercially available digital optimization technology can be defined as plant and process modelling platforms that may employ first principles models 82 and/or data driven models 84 that can utilize conventional and/or advanced analytics. An example of an application using this form of digital technology is the modelling of process digital twins. The model can include individual process unit models and a system model, including the in-scope process units. The model can be built with varying degrees of detail, dependent on specifications and requirements. For example, process units requiring detailed modelling include heat recovery and heat integration assets such as heat exchangers, fired heaters, furnaces, and process steam consumers.

The efficiency model 80 can be implemented as an open-ended system to generate predictive optimized heat/energy scenarios that generate recommended adjustments or changes to operational parameters 100. The outputs 68 of the efficiency model 80 are intended to enhance and accelerate an engineer's or an operator's decision-making and actions anticipated to result in reduced GHG emissions. The results of the model can be exported to the existing data historian and the output of the model and the end user functionality can be built into existing work practices and graphic user interfaces.

The efficiency model 80 can also be implemented as a closed system, in which the outputs 68 of the efficiency model 80 are in the form of changes to the operational parameters 100. These changes can include, without limitation, set points and operating limits that can be directly inputted into the plant's process control system resulting in automatic changes to operational controls 20. It should be noted that the efficiency model 80 functions should be within the constraints of production rates, the technical operating envelope for each process unit, and safe operating limits.

The efficiency model 80 can be used selectively or continuously over time to determine an energy optimization 94 to achieve an objective, such as a GHG reduction 98 as illustrated in FIG. 5. The energy optimization 94 is a function of the efficiency model 80. The energy optimization 94 that results in a reduction of GHG emissions 98 is an important goal of the efficiency model 80. This energy optimization 94 is generated using the native process optimization algorithms inside the first principles model 82 and the data driven model(s) 84. That is, the energy optimization 94 and minimizing GHG emissions are the objective functions of the efficiency model 80. The resultant output 68 of the efficiency model can include recommended changes and adjustments to operational parameters 100. The operational parameters 100 are used to refine the operational controls 20 for the plant 14 to improve the energy optimization 94 at the next iteration of the modelling and analysis. The information and data from the sensors 18, the energy/GHG data and costs 88, the production and plant operating data 86, and pricing 96 are the inputs to and provide feedback to all components of the efficiency model 80, the first principles model 82, the data driven models 84, and the energy optimization function 94. As shown in FIG. 5, the additional feedback data to the efficiency model 80 enables the efficiency model 80 to learn or be trained to adapt to changing outputs.

The operational parameters 100 can include settings, set points, thresholds, operating limits, or other values that inform the operational controls 20 as to any changes to the operations of the plant 14. As discussed above, this can include values that can be used to inform an operator for manual adjustment and/or values that can be sent as inputs to an automated or semi-automated system. The GHG analysis system 12 can also provide predictive optimization modes to provide recommended optimization scenarios and actions to, for example, reduce process steam use, fuel combustion, and improve heat integration and heat recovery, thereby reducing GHG emissions.

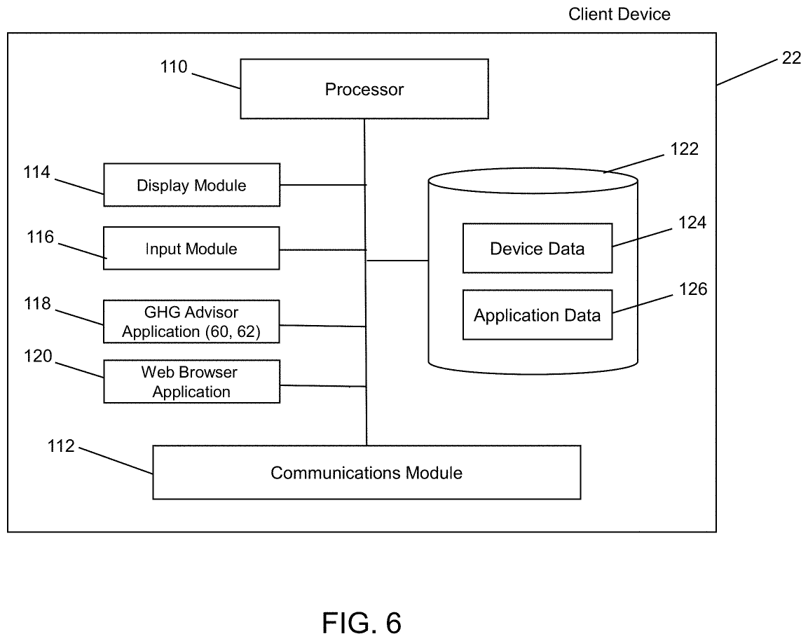

The GHG analysis system 12 and efficiency model 80 generated, trained and used as herein described, can be utilized by a client device 22 as shown in FIG. 1. In FIG. 6, an example configuration of the client device 22 is shown. In certain embodiments, the client device 22 may include one or more processors 110, a communications module 112, and a data store 122 storing device data 124 and application data 126. Communications module 112 enables the client device 22 to communicate with one or more other components of the monitoring system 10, such as the GHG analysis system 12, via a bus or other communication network, such as the network 16. While not delineated in FIG. 6, the client device 22 includes at least one memory or memory device that can include a tangible and non-transitory computer-readable medium having stored therein computer programs, sets of instructions, code, or data to be executed by processor 110. FIG. 6 illustrates examples of modules and applications stored in memory on the client device 22 and operated by the processor 110. It can be appreciated that any of the modules and applications shown in FIG. 6 may also be hosted externally and be available to the client device 22, e.g., via the communications module 112.

In the example implementation shown in FIG. 6, the client device 22 includes a display module 114 for rendering GUIs and other visual outputs on a display device such as a display screen, and an input module 116 for processing user or other inputs received at the client device 22, e.g., via a touchscreen, input button, transceiver, microphone, keyboard, etc. The client device 22 may also include a GHG advisor application 118 provided by the enterprise or organization associated with the GHG analysis system 12 which, as shown in FIG. 6, can provide a platform or modules to implement the energy monitoring system 60 and/or GHG/energy optimizer 62. The client device 22 in this example embodiment also includes a web browser application 120 for accessing Internet-based content, e.g., via a mobile or traditional website.

The data store 122 may be used to store device data 124, such as, but not limited to, an IP address or a MAC address that uniquely identifies client device 22 within the system 10. The data store 122 may also be used to store application data 126, such as, but not limited to, login credentials, user preferences, cryptographic data (e.g., cryptographic keys), etc.

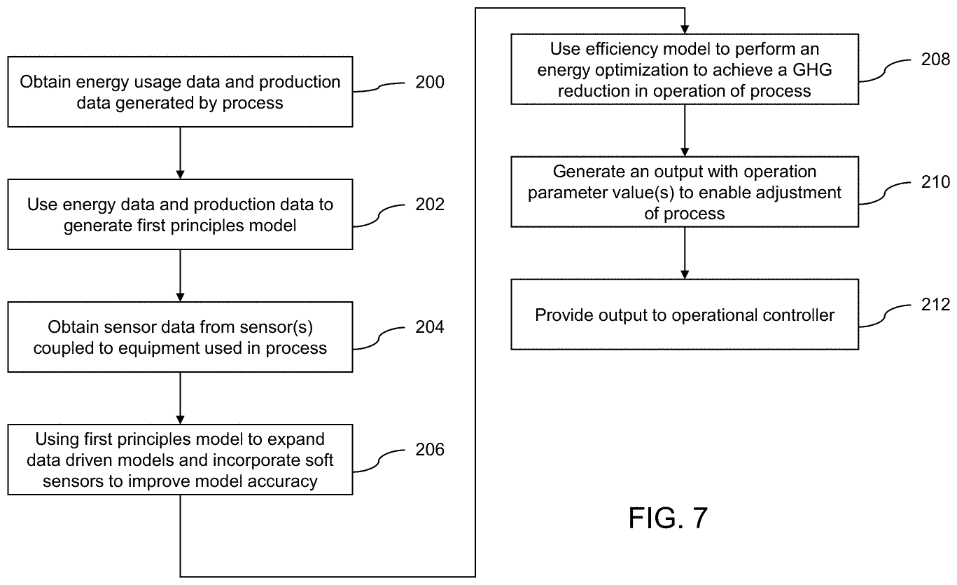

Turning now to FIG. 7, computer executable operations are shown that can be implemented by the GHG analysis system 12 to determine operational parameters for improving energy efficiency of a process such as that executed in a plant 14. At 200, the system 12 obtains energy usage data 88 and production data 86 generated by the process operating in the plant 14. At 202, the analysis system 12 uses the energy data 88 and the production data 86 to generate the first principles model 82. The system 12 can also obtain sensor data from the sensors 18 coupled to equipment 30 in the plant 14 at 204, to generate the first principles model and soft sensor data can be obtained to fill in the gaps that remain in the first principles model 82. This allows the efficiency model 80 to be generated at 206 by applying conventional or advanced analytics associated with the data driven models 84 to or with the first principles model 82 and expanding the data driven models 84, where necessary, using the first principles model 82 and the sensor data or vice versa.

The efficiency model 80 can then be used at 208 to perform an energy optimization at 208 to achieve a GHG reduction in operation of the process. In this way, the efficiency model 80 can be used continuously or at least more frequently than a traditional energy monitoring system 60 or only a first principles model 82. At 210, the system 12 can generate an output with operation parameter values to enable the process to be adjusted. For example, the process parameter values can include an increase or decrease in an input or a new temperature range, etc. For example, if the GHG analysis system 12 detects or anticipates a decrease in hydrocarbon flow rate, it can call for a corresponding decrease in utility flow rates so that the hydrocarbon's per parrel energy use is optimized as much as the other process constraints will allow. At 212 the output can be provided to an automated system or an operator for manual adjustment.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, cloud storage, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the GHG analysis system 12 or client device 22, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of determining operational parameters for improving energy efficiency of a process, comprising:
obtaining energy usage data and production and operating data generated by utilizing at least one utility in the process;
using the energy data and production and operating data to generate a first principles model;
obtaining sensor data from at least one sensor coupled to equipment used during operation of the process;
generating an efficiency model using at least one data driven model, the sensor data, and the first principles model;
using the efficiency model to generate an energy optimization to achieve a greenhouse gas reduction in operation of the process;
generating an output comprising at least one operation parameter value to enable adjustment of the equipment to adjust operation of the process towards the greenhouse gas reduction; and
providing the output to an operational controller.

2. The method of claim 1, wherein the sensor data comprises real-time or near-real-time usage data associated with the at least one utility.

3. The method of claim 1, wherein the operational controller comprises a device configured to automatically apply the at least one adjustment.

4. The method of claim 1, wherein the operational controller comprises an operator instructed to perform at least one manual adjustment.

5. The method of claim 1, wherein the energy usage data comprises emissions data.

6. The method of claim 1, further comprising:
obtaining at least one process constraint; and
using the at least one process constraint in generating the efficiency model.

7. The method of claim 1, further comprising:
obtaining at least one production target; and
using the at least one production target in generating the efficiency model.

8. The method of claim 1, further comprising:
obtaining pricing data associated with energy consumption used in the process; and
using the pricing data in performing the energy optimization.

9. The method of claim 1, further comprising:
generating energy and/or greenhouse gas cost values associated with the process; and
feeding the energy and/or greenhouse gas cost values to the efficiency model to refine the efficiency model.

10. The method of claim 9, wherein the feedback for the efficiency model is provided prior to generating the operational parameters to iterate the energy optimization.

11. The method of claim 1, wherein the equipment is operable within an industrial plant.

12. The method of claim 1, wherein the sensor data further comprises soft sensor data.

13. The method of claim 1, wherein the process comprises at least one of recovery, upgrading, refining, and use of a utility, in processing a hydrocarbon.

14. The method of claim 13, wherein the hydrocarbon comprises bitumen.

15. The method of claim 1, further comprising:
receiving data from a separate energy monitoring system; and
utilizing the data from the energy monitoring system in generating the energy optimization.

16. The method of claim 1, further comprising obtaining data from a data historian.

17. The method of claim 16, further comprising feeding the at least one operation parameter value back to the data historian.

18. The method of claim 1, further comprising connecting to the operational controller in a plant implementing the process over an electronic data communications network.

19. The method of claim 1, further comprising connecting to the at least one sensor in a plant implementing the process over an electronic data communications network.

20. The method of claim 1, further comprising providing information indicative of the energy optimization and the output to an application comprising a graphical user interface.

21. The method of claim 20, wherein the application is a mobile app.

22. The method of claim 1, wherein the energy efficiency model is generated by using the first principles model to expand the at least one data driven model while incorporating sensor data when applicable to increase model accuracy.

23. The method of claim 1, wherein the at least one data driven model is used to apply data analytics to the sensor data, energy data, and production and operating data.

24. A computer readable medium comprising computer executable instructions for determining operational parameters for improving energy efficiency of a process, comprising instructions for:
obtaining energy usage data and production and operating data generated by utilizing at least one utility in the process;
using the energy data and production and operating data to generate a first principles model;
obtaining sensor data from at least one sensor coupled to equipment used during operation of the process;
generating an efficiency model using at least one data driven model, the sensor data, and the first principles model;
using the efficiency model to generate an energy optimization to achieve a greenhouse gas reduction in operation of the process;
generating an output comprising at least one operation parameter value to enable adjustment of the equipment to adjust operation of the process towards the greenhouse gas reduction; and
providing the output to an operational controller.

25. A system for determining operational parameters for improving energy efficiency of a process, the system comprising a processor, memory, and at least one data communication interface, the memory comprising computer executable instructions that when executed by the processor, cause the processor to:
obtain energy usage data and production and operating data generated by utilizing at least one utility in the process;
use the energy data and production and operating data to generate a first principles model;
obtain sensor data from at least one sensor coupled to equipment used during operation of the process;
generate an efficiency model using at least one data driven model, the sensor data, and the first principles model;
use the efficiency model to generate an energy optimization to achieve a greenhouse gas reduction in operation of the process;
generate an output comprising at least one operation parameter value to enable adjustment of the equipment to adjust operation of the process towards the greenhouse gas reduction; and
provide the output to an operational controller.
